(19) United States
(12) Patent Application Publication
(10) Pub. No.: US 2021/0172372 A1
(43) Pub. Date: Jun. 10, 2021

(54) METHOD FOR STORING AND PRODUCTION ENERGY BY MEANS OF COMPRESSED AIR WITH ADDITIONAL ENERGY RECOVERY

(71) Applicant: IFP Energies nouvelles, Rueil-Malmaison (FR)

(72) Inventors: Patrick BRIOT, POMMIER DE BEAUREPAIRE (FR); David TEIXEIRA, CROISSY-SUR-SEINE (FR)

(21) Appl. No.: 16/771,546

(22) PCT Filed: Nov. 14, 2018
(86) PCT No.: PCT/EP2018/081168

§ 371 Date: Jun. 10, 2020

(30) Foreign Application Priority Data
Dec. 11, 2017 (FR) 1761916

(51) Int. Cl. F02C 6/16; F01D 25/32; F02C 1/04; F02C 6/18; F02C 7/143; F02C 9/16

(52) U.S. Cl. CPC F02C 6/16; F01D 25/32; F02C 9/16; F02C 6/18; F02C 7/143; F02C 1/04

(57) ABSTRACT

The invention relates to a compressed-air energy storage and production method comprising the following steps:
compression of the air by staged compressors, during which cooling of the air after at least one compression step is performed through exchange with a heat transfer fluid,
storage of the compressed air and of the hot heat transfer fluid after exchange during compression,
staged expansions of the air by power generation turbines, during which heating of the air is performed after at least one step of expansion by said hot heat transfer fluid from said storage. According to the invention, after heating the expanded air and prior to being recycled to the compression step, the heat transfer fluid is cooled by an additional energy recovery loop comprising a pump, an exchanger and a turbine, as well as an additional transfer fluid.

### FIELD OF THE INVENTION

The present invention relates to the field of energy storage and production by air compression and expansion.

### BACKGROUND OF THE INVENTION

Electricity production from renewable energies, sun by means of solar panels, wind by means of onshore or offshore turbines, is booming. The main drawbacks of these production means are intermittent production and the possible mismatch between the production period and the consumption period. There is therefore a need for means of storing electricity during production so as to release it when needed or in case of over-consumption. There are many technologies allowing this balance to be achieved, the best known of which being the Pumped Storage Plant (PSP), which uses two water reservoirs at different elevations. The water is pumped from the lower basin during the charging phase and it is sent by a turbine to the lower basin during discharge. Other technologies may use batteries of different types (lithium, nickel, sodium-sulfur, lead-acid, etc.). Flywheel Energy Storage (FES) consists in accelerating a rotor (flywheel) to a very high speed and in maintaining the energy in the system in form of kinetic energy. When energy is extracted from the system, the rotational speed of the flywheel is reduced as a consequence of the energy conservation principle. Adding energy to the system therefore causes an increase in the flywheel speed.

Most FES systems use electricity for flywheel acceleration and deceleration, but devices directly using mechanical energy are under development.

The energy storage technology using compressed air is promising. The produced energy that is not consumed is used for compressing air to pressures ranging between 40 bars and 200 bars using multi-stage compressors. In order to minimize the electricity consumption of each compressor, the heat resulting from compression is eliminated between each stage. The compressed air is then stored under pressure, either in natural cavities (caves) or in artificial reservoirs.

During the electricity production phase, the stored air is then sent to turbines so as to produce electricity. Upon expansion, the air cools down. In order to avoid too low temperatures (−50° C.) causing damage to the turbines, the air needs to be heated prior to expansion. Such plants have been operating for a number of years now. Among the best known are the Huntorf plant in Germany, operating since 1978, and the Macintosh plant in the USA (Alabama), since 1991. These two plants have the particular feature of using the stored compressed air for feeding gas turbines. These gas turbines burn natural gas in the presence of air under pressure in order to generate very hot combustion gases (550° C. and 825° C. for the Huntorf plant) at high pressure (40 bars and 11 bars) prior to expanding them in turbines generating electricity. This type of process emits carbon dioxide. The Huntorf plant could emit approximately 830 kg CO₂ per megawatt of electricity produced.

There is a variant under development. It is a so-called adiabatic process wherein the heat resulting from the compression of air is recovered, stored and released to the air prior to expanding it upon energy recovery.

Cooling the air during compression can be done using exchangers without direct contact between the fluids, thus only the heat is transferred from the hot air to the cold fluid. This fluid may be a liquid (water, organic liquid, mineral liquid) or a gas. This fluid becomes very hot and it is stored or not in order to heat the cold air prior to expansion.

Patent application US-2013/0,042,601 describes air cooling between the compression stages by water through exchangers without direct contact. The hot water is subsequently cooled. The heat required during expansion is provided by hydrocarbon combustion in high-pressure and low-pressure burners. A similar description is made in documents US-2014/0,026,584 A1 and US-2016/0,053,682 A1.

Exchangers without direct contact can be plate (welded or not) exchangers, shell-and-tube exchangers or any device known to the person skilled in the art using heat exchange without matter transfer.

Document WO-2016/012,764 A1 describes such an indirect exchange between hot air resulting from compression and a molten salt using exchangers, the air prior to expansion being heated by means of the previously obtained hot molten salt. Such a system is also used in document DE-10-2010/055,750 A1, where the fluid used for transferring the compression heat to expansion is a saline water solution through exchangers.

Cooling of the air can also be done by means of so-called direct-contact exchangers, i.e. the hot air is sent into a column wherein a cold liquid is sent counter-current to the air. The heat of the air is then transferred to the cold fluid that heats up on contact. In addition to the heat, matter transfers may also occur upon contact. These columns generally contain elements allowing contact between the gas phase (air) and the liquid phase (cold fluid) to be improved, so as to facilitate gas-liquid transfer. These elements may be packings, structured or random, distributor trays equipped with chimneys. There are also direct-contact systems based on solids. Document US-2016/0,326,958 A1 describes a system where heat transfer occurs through direct contact with phase-change materials. Document US-2011/0,016,864 A1 uses a heat transfer technology through direct contact with molten salts.

To minimize the material cost, the same equipments are used for cooling the hot air from compression and for heating the air after expansion because the process operates in a cyclic manner. This is described in document DE-10-2010/055,750 A1 for the technology without direct contact, and in patent applications US-2011/0,016,864 A1 and US-2016/0,326,958 A1 for the direct-contact heat exchange technology.

There is a thermal imbalance between the heat produced by compression and the heat used for heating the air during expansion. When a fluid is used to transfer the heat from compression to expansion, this fluid remains hot, with temperatures above the initial temperature acceptable for cooling. This requires cooling prior to recycling it to be reused.

The object of the present invention is to improve the performance of the electricity storage and production plant by using part of the heat of the heat transfer fluid, whatever the nature of the heat transfer fluid (water, mineral oil, etc.), so as to produce additional electricity and to reduce the amount of cold required for cooling said heat transfer fluid prior to recycling it.

### SUMMARY OF THE INVENTION

The present invention thus relates to a compressed-air energy storage and production method comprising the following steps:
compression of the air by staged compressors, during which cooling of the air is performed after at least one compression stage through exchange with a heat transfer fluid,
storage of the compressed air and of said hot heat transfer fluid after exchange during compression,
staged expansions of the air by power generation turbines, during which heating of the air is performed after at least one step of expansion by said hot heat transfer fluid from said storage.

According to the invention, after heating the expanded air and prior to being recycled to the compression step, said heat transfer fluid is cooled by an additional energy recovery loop comprising a pump, an exchanger and a turbine, as well as an additional transfer fluid.

The fluid used for heat transfer with the air can be selected from among water, mineral oils, ammonia solutions.

The additional transfer fluid can be selected from among hydrocarbons, such as butane and propane, and ammonia solutions.

The heat exchange equipments can be common to the compression and compressed air expansion steps.

The heat exchange equipments can use the technology of heat exchange without direct contact between the fluids.

The heat exchange equipments can use the technology of heat exchange with direct contact between the fluids.

At least one separator can be arranged on the compressed or expanded air line, so as to control a mass transfer between said heat transfer fluid and the air.

The direct-contact heat exchange equipments can comprise packed columns or plate columns.

According to an aspect, said heat transfer fluid is stored in an intermediate storage means prior to exchanging heat with said additional transfer fluid.

Furthermore, the invention relates to a compressed-air energy storage and production system comprising:
a) staged compressors, and at least one heat exchanger with a heat transfer fluid is arranged between a compression stage,
b) a compressed air storage means and a means of storing said hot heat transfer fluid after exchange during compression,
c) power generation turbines, and at least one heat exchanger with said heat transfer fluid is arranged between an expansion stage, said system comprises an additional energy recovery loop including a pump, an exchanger, a turbine and an additional transfer fluid, said additional recovery loop being positioned after heating of the expanded air and prior to being recycled to the compression step.

According to an embodiment, the fluid used for heat transfer with the air is selected from among water, mineral oils, ammonia solutions.

According to an implementation, the additional transfer fluid is selected from among hydrocarbons, such as butane and propane, and ammonia solutions.

Advantageously, the heat exchangers are common to the compression and compressed air expansion steps.

According to an aspect, at least one heat exchanger uses the technology of heat exchange without direct contact between the fluids.

According to an embodiment, at least one heat exchanger uses the technology of heat exchange with direct contact between the fluids.

According to an implementation of the invention, at least one separator is arranged on the compressed or expanded air line, so as to control a mass transfer between said heat transfer fluid and the air.

Advantageously, the direct-contact heat exchange equipments comprise packed columns or plate columns.

Advantageously, said system comprises a means for intermediate storage of said heat transfer fluid positioned before said additional recovery loop.

### BRIEF DESCRIPTION OF THE FIGURES

Other features and advantages of the invention will be clear from reading the description hereafter of embodiments given by way of non-limitative example, with reference to the accompanying figures wherein:

FIG. 1 describes a compressed-air energy storage and production method according to the prior art wherein the heat transfer fluid is water,

FIG. 2 describes the method according to FIG. 1 including an additional recovery loop according to the invention,

FIG. 3 describes a compressed-air energy storage and production method according to the prior art wherein the heat transfer fluid exchanges heat in direct contact with the air, and

FIG. 4 describes the method according to FIG. 3 including an additional recovery loop according to the invention.

### DETAILED DESCRIPTION OF THE INVENTION

The present invention proposes using, in a CAES type method or system, a loop for additional heat recovery from the heat transfer fluid used for transferring the heat recovered during air compression and after using this heat during expansion.

The invention is suited for any CAES system and method wherein heat exchanges between the compression and expansion stages comprise at least one heat exchange with a heat transfer fluid. The system and the method comprise at least one cold storage means for storing the cold transfer fluid prior to using it in at least one heat exchanger arranged in the compression line (between the compression stages). Furthermore, the system and the method comprise at least one hot storage means for storing the hot transfer fluid prior to using it in the expansion line (between the expansion stages).

The additional recovery loop is positioned at the outlet of the expansion stages and before reinjection of the heat transfer fluid into the cold storage means.

This additional recovery means is based on cycles using hydrocarbons or ammonia solutions whose nature may be selected depending on the final temperature of the heat transfer fluid. This loop comprises two steps:
a step wherein the hot transfer fluid is placed in indirect contact with an additional transfer fluid, such as a hydrocarbon, under temperature and pressure conditions where the hydrocarbon is liquid. During this contact, the hot transfer fluid is cooled to a temperature close to but higher than the incoming liquid hydrocarbon. The liquid additional transfer fluid (hydrocarbon for example) vaporizes during this indirect contact,
the additional transfer fluid vapours (hydrocarbon vapours for example) are sent to a turbine where they are expanded to such a pressure that the temperature is close to but higher than the temperature of the coolant (air, water, etc.). After this expansion, the vapours are sent to an exchange device without direct contact with air (or water) to be condensed. The pressure of the liquid thus obtained returns to the initial value before vaporization by means of a pump.

According to the invention, using an additional cooling cycle for the additional transfer fluid (that may comprise hydrocarbons, whose nature is selected depending on the temperature of the water) allows the CAES method and system to produce more electricity and to expend less energy for cooling the recycled transfer liquid, water or oil for example. This gain is all the more significant since the final temperature of the transfer liquid is higher.

According to an implementation of the invention, the system and the method can comprise at least one intermediate storage means for storing the heat transfer fluid after the heat exchanges provided in the expansion line (after the expansion stages). In this case, the additional recovery loop is intended for recovery of the heat contained in this intermediate storage means.

After heat exchange between the heat transfer fluid and the additional transfer fluid, the transfer fluid can be sent back to the cold storage means.

Thus, for this implementation of the invention, the heat transfer fluid is subjected to the following loop:
storage in the cold storage means,
at least one heat exchange with the gas in the compression line,
storage in the hot storage means,
at least one heat exchange with the gas in the expansion line,
storage in the intermediate storage means,
heat exchange with the additional transfer fluid of the additional recovery loop, and
transfer to the cold storage means.

According to an embodiment of the invention, the CAES system and method can have at least one of the following features:
the fluid for heat transfer with air is selected from among water, mineral oils, ammonia solutions,
at least one direct-contact heat exchanger,
at least one heat exchanger without direct contact, preferably provided with packed columns or plate columns,
at least one separator arranged on the compressed or expanded air line, so as to control a mass transfer between said heat transfer fluid and the air,
the heat exchangers may be common to the compression line and the expansion line, so as to limit the number of devices in the system.

In the description of the various examples and of the invention, the same equipments are used for compression and expansion of the air. The characteristics of the compressors and turbines used are given in the table hereafter.

| | Pressure ratio | Efficiency (%) |
|---|---|---|
| Compressors | | |
| K-101 | 5.22 | 84.3 |
| K-102 | 4.435 | 83 |
| K-103 | 2.7974 | 81.4 |
| K-104 | 2.3422 | 71.8 |
| Turbines | | |
| EX-201 | 0.59 | 78 |
| EX-202 | 0.51 | 80.50 |
| EX-203 | 0.15 | 83 |
| EX-204 | 0.1861 | 85.50 |

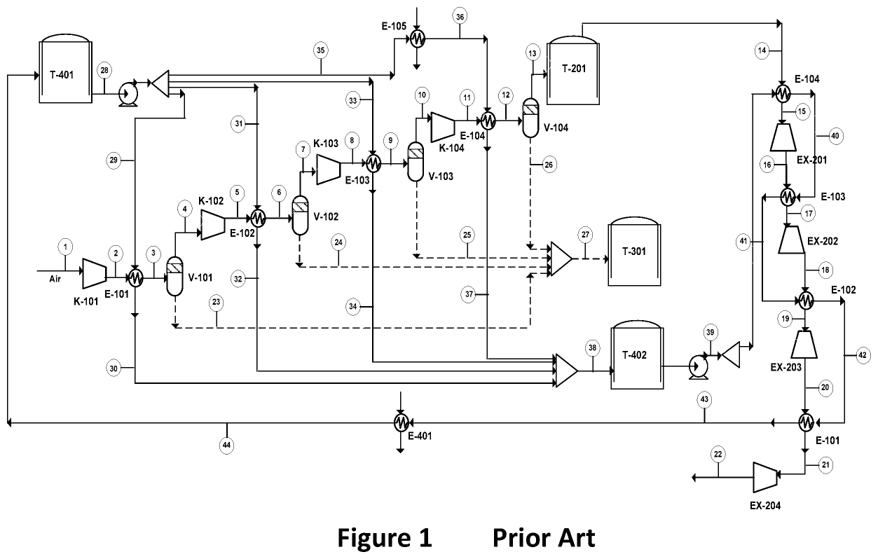

### Example 1: According to the Prior Art (FIG. 1)

This example can be a description of the method with water as the heat transfer fluid instead of a saline solution as described in patent DE-10-2010/055,750 A1.

Outside air (flow 1), at a temperature of 20° C. and a pressure of 1,014 bar, containing 4.2 mol % water, is fed to a compression stage K-101 from where it flows at a higher pressure and at a higher temperature (flow 2). This flow 2 is then cooled to 50° C. in an exchanger (E-101) without direct contact (flow 3) by water at 40° C. (flow 29). The water leaves the exchanger at a higher temperature (flow 30) and it is sent to a storage tank (T-402). The humidity of the cooled air condenses (flow 23) and it is separated from the air (flow 4) in a gas/liquid separator (V-101). This condensed water is thereafter sent to a storage tank (T-301). The air then flows into a second compression stage (K-102) which it leaves at a higher pressure and temperature (flow 5). It is cooled in an exchanger without direct contact (E-102) with cold water (flow 31). The hot water leaving the exchanger (flow 32) is sent to a storage tank (T-402). The cooled air (flow 6) enters a gas/liquid separator (V-102) separating the condensed humidity (flow 24) from the cold air (flow 7). The condensed humidity is sent to a storage tank (T-301). The cooled air (flow 7) enters a third compression stage (K-103) which it leaves (flow 8) at a higher pressure and temperature. It is then cooled in an exchanger without direct contact (E-103) with cold water (flow 33). This hot water is sent to a storage tank (T-402). The cold air enters a gas/liquid separator (V-103) where the condensed humidity (flow 25) is separated from the air (flow 10). This condensed humidity is then sent to a storage tank (T-301). The cold air (10) leaving separator (V-103) then enters a last compression stage (K-104) which it leaves (flow 11) at a higher pressure and temperature. It is cooled in an exchanger without direct contact (E-104) with cold water (flow 36). This flow 36 can be cooled, by means of an exchanger (E-105), to a lower temperature than that of the water used for cooling the compression stages. The hot water (flow 37) leaving exchanger (E-104) is sent to a storage tank (T-402). The cold air (flow 12) enters a gas/liquid separator (V-104) where the condensed humidity (flow 26) is sent to a storage tank (T-301). The cold air (flow 13), 50,000 kg/h, leaving at a pressure of 136.15 bars and at a temperature of 30° C., is sent into a storage tank (T-201), which may be either natural or artificial. It now contains only 300 ppm water. The power consumption for the compression step is 10.9 MW. The condensed water represents an amount of 1.35 t/h.

During electricity production, the stored air (flow 14) is sent from tank (T-201) to an exchanger without direct contact (E-104) with the hot water (flow 39) from storage tank (T-402). Exchanger (E-104) is the same as the one used for cooling during compression. This economy of equipments is possible because, the process being cyclic, the exchangers are used either during compression or during expansion. The block diagram describes all the fluid circulations, but not the details of all the pipes required for alternate use of the exchangers.

The hot air (flow 15) enters a turbine EX-201 where it undergoes expansion. The cooled water (flow 40) leaving exchanger E-104 is sent to exchanger E-103 without direct contact where it heats the cooled expanded air (flow 16). This heated air (flow 17) is sent to a second turbine EX-202 where it is expanded to a lower pressure (flow 18). The cooled water (flow 41) leaving exchanger E-103 is sent to exchanger E-102 without direct contact where it heats the air leaving turbine EX-202, which is then heated (flow 19). This hot air is then sent to a third turbine EX-203 where it is expanded to a lower pressure (flow 20). The less hot water (flow 42) leaving exchanger E-102 is sent to another exchanger without direct contact E-101. This exchanger is used for heating the air (flow 20) leaving turbine EX-203 prior to entering (flow 21) the last turbine EX-204. After final expansion, the air is released to the atmosphere (flow 22) at a pressure of 1.02 bar and a temperature of 10° C.

The water used for the various air heating cycles prior to expansion (flow 43) is at a final temperature of 126° C. Prior to being recycled, this water needs to be cooled, either by a water exchanger or by an air cooler. The required cooling power is 5.5 MWth.

The power produced by the successive expansions is 5.2 MWe.

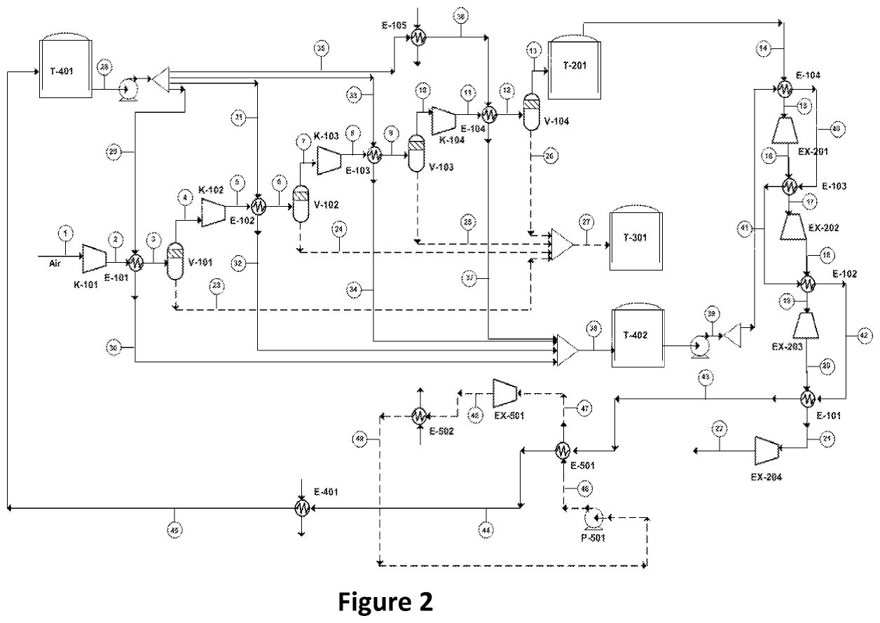

### Example 2: According to the Invention (FIG. 2)

The compressed-air energy storage and production method is identical to the one described in Example 1.

Similarly, the air after final expansion is released to the atmosphere (flow 22) at a pressure of 1.02 bar and a temperature of 10° C.

The hot water used as the heat transfer fluid for the various air heating cycles prior to expansion (flow 43) is at a final temperature of 126° C.

According to the invention, this hot water is sent to an additional heat transfer device without direct contact E-501 where it is cooled (flow 44) to a temperature of 50° C. by heat exchange with a flow of liquid butane (flow 46). This flow of liquid butane, at a pressure of 21 bars and a temperature of 41.4° C., is vaporized during heat exchange and it is then at a pressure of 20.5 bars and a temperature of 116° C. The cooled water (flow 44) is then sent to an exchanger (E-401) where it is cooled by water or air at a temperature of 40° C. (flow 45).

The vaporized butane (flow 47) is sent to a turbine (EX-501) to be expanded to a pressure of 4 bars. The flow (flow 48) is then sent to a heat transfer device (E-502) to be condensed to 40° C. and to a pressure of 3.88 bars. The pump (P-501) brings the flow of liquid butane (flow 49) back to a pressure of 21 bars and a temperature of 41.4° C. in order to be recycled to the additional heat transfer device without direct contact E-501.

The required cooling power of equipments E-401 and E-502 is 4.9 MWth, to be compared with the 5.5 MWth of the previous example.

Expansion of the butane, reduced by the power consumption of pump P-501, produces 0.55 MWe, to be added to the 5.2 MWe of the air cycle, making a total of 5.75 MWe.

Thus, providing an additional loop for recovering energy from the heat transfer fluid heating the air expanded in the turbine stages increases the overall process efficiency.

The additional recovery fluid may be a hydrocarbon, for example butane, propane, and it may also come in form of ammonia or of an ammonia solution.

In a more general manner, the invention also comprises a method wherein a single or more compression and expansion stages are concerned.

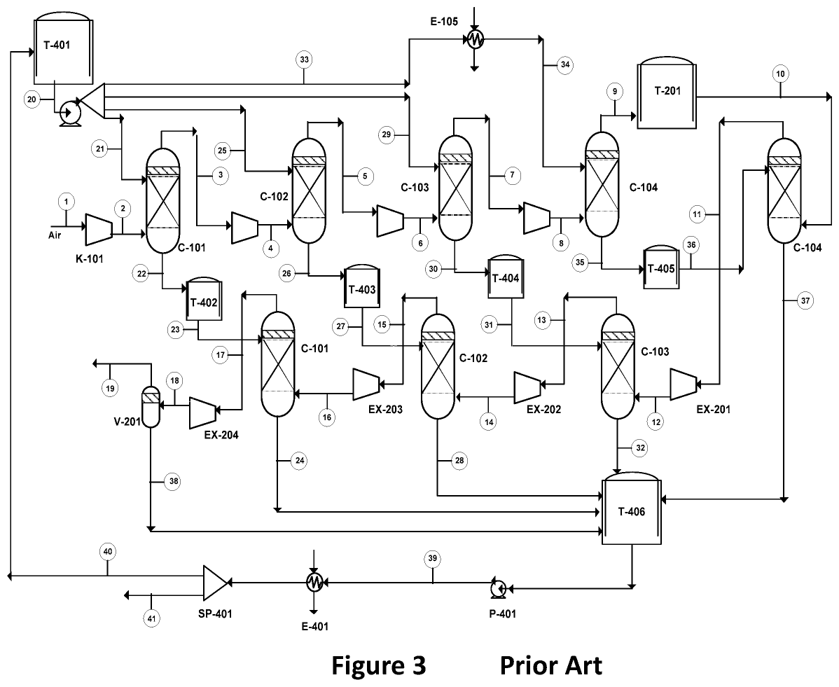

### Example 3: According to the Prior Art (FIG. 3)

Outside air (flow 1), at a temperature of 20° C. and a pressure of 1,014 bar, containing 4.2 mol % water, is fed to a compression stage K-101 from where it flows at a higher pressure and at a higher temperature (flow 2). This flow 2 is then cooled to 50° C. in a direct-contact heat exchanger (C-101) by water at 40° C. (flow 21). This heat exchanger (C-101) consists of a packed column into which the hot air (flow 2) flows through the bottom of the column. The cold water (flow 21) is injected at the top of the column, thus resulting in a cross-flow: one flow (air) moves upward while the other (water) moves downward. The hot water leaves the column at the bottom at a higher temperature (flow 22) and it is sent to a storage tank (T-402). The cooled air leaves the column at the top (flow 3) and it flows into a second compression stage (K-102) which it leaves at a higher pressure and temperature (flow 4). It is then cooled in a direct-contact heat exchanger (C-102) with cold water (flow 25). The hot water leaving the column in the bottom (flow 26) is sent to a storage tank (T-403). The cooled air (flow 5) enters a third compression stage (K-103) which it leaves (flow 6) at a higher pressure and temperature. It is then cooled in a direct-contact heat exchanger (C-103) with cold water (flow 29). This hot water (flow 30) is sent to a storage tank (T-404). The cold air (flow 7) leaves the column at the top and it flows into a last compression stage (K-104) which it leaves (flow 8) at a higher pressure and temperature. It is then cooled in a direct-contact heat exchanger (C-104) with cold water (flow 34). This flow 34 can be cooled, by means of a heat exchanger E-105, to a lower temperature than the water used for cooling the compressor stages. The hot water (flow 35) leaving the bottom of column (C-104) is sent to a storage tank (T-405). The cold air (flow 9), 50,000 kg/h, leaving at a pressure of 134.34 bars and at a temperature of 30° C., is sent into a storage tank (T-201), which may be either natural or artificial. It now contains only 320 ppm water. The power consumption for the compression step is 10.9 MW, thus identical to Examples 1 and 2.

During electricity production, the stored air (flow 10) is sent from tank (T-201) to a direct-contact heat exchanger (C-104) with the hot water (flow 36) from storage tank (T-405). Exchanger (C-104) is the same as the column used for cooling during compression. This economy of equipments is possible because, the process being cyclic, the exchangers are used either during compression, or during expansion. The block diagram describes all the fluid circulations, but not the details of all the pipes required for alternate use of the exchangers.

The hot air (flow 11) leaves the column at the top and it enters a turbine EX-201 where it undergoes expansion. The cooled water (flow 37) leaving the bottom of column C-104 is sent to a storage tank T-406, also referred to as intermediate storage means. The air leaving turbine EX-201 is sent (flow 12) to direct-contact heat exchanger C-103 where it is heated by water circulating in a counter-current flow from storage tank T-404 (flow 31). The cooled water (flow 32) is sent to a storage tank (T-406). This heated air (flow 13) is sent to a second turbine EX-202 where it is expanded to a lower pressure (flow 14). It is then heated by water (flow 27) from storage tank T-403. The cooled water (flow 28) leaving the bottom of column C-102 is sent to a storage tank T-406. The heated air (flow 15) is sent to a turbine EX-203 where it is expanded to a lower pressure (flow 16). This cold air is heated by hot water (flow 23) from storage tank T-402 in direct-contact heat exchanger C-101. This cooled water (flow 24) is sent to a storage tank T-406. The heated air (flow 17) is then sent to a last turbine EX-204 to be expanded to a lower pressure (flow 18). This cold air is thereafter sent to a gas/liquid separator V-201 in order to separate the air (flow 19) from the liquid water that may be present (flow 38). This water is sent to storage tank T-406. The air, 50,800 kg/h, after final expansion is released to the atmosphere (flow 19) at a pressure of 1.02 bar and a temperature of 22° C. The hot water used for the various air heating cycles prior to expansion (flow 39) is at a final temperature of 65.7° C. Prior to being recycled, this water needs to be cooled, either by a water exchanger or by an air cooler. The required cooling power is 5.3 MWth.

The power produced by the successive expansions is 4.45 MWe.

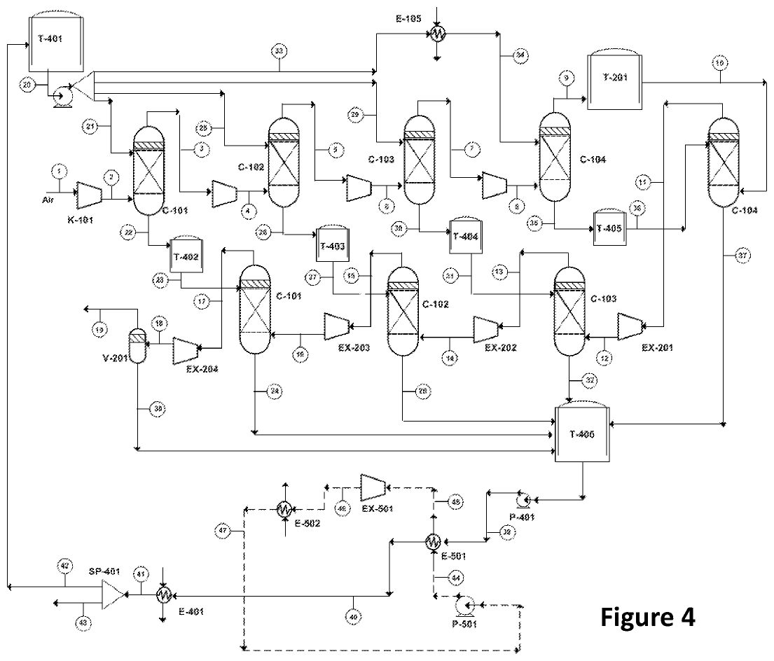

### Example 4: According to the Invention (FIG. 4)

FIG. 4 illustrates, by way of non-limitative example, an embodiment of the invention.

The compressed-air energy storage and production method is identical to the one described in Example 3.

Similarly, the air, 50,800 kg/h, after final expansion is released to the atmosphere (flow 19) at a pressure of 1.02 bar and a temperature of 22° C. The hot water used for the various air heating cycles after expansion (flow 39) is at a final temperature of 65.7° C. in tank T-406.

This hot water is then sent to a heat transfer device without direct contact E-501 where it is cooled (flow 40) to a temperature of 50° C. by heat exchange with a flow of liquid propane (flow 44). This flow of liquid propane, at a pressure of 19.5 bars and a temperature of 40.8° C., is vaporized during heat exchange and it is then at a pressure of 19 bars and a temperature of 55.6° C. The cooled water (flow 40) is sent to an exchanger (E-401) where it is cooled by water or air at a temperature of 40° C. (flow 41).

The vaporized propane (flow 45) is sent to a turbine (EX-501) to be expanded to a pressure of 14.3 bars. It is then sent to a heat transfer device (E-502) to be condensed to 40° C. and to a pressure of 13.9 bars. Pump P-501 brings the liquid propane back to a pressure of 19.5 bars and to a temperature of 40.8° C.

The required cooling power of equipments E-401 and E-502 is 5.2 MWth, to be compared with the 5.3 MWth of the previous example.

Expansion of the propane, reduced by the power consumption of pump P-501, produces 0.09 MWe, to be added to the 4.45 MWe of the air cycle, making a total of 4.54 MWe.

In a more general manner, the invention also comprises a method and a system wherein a single or more compression and expansion stages are concerned.

The summary table hereafter gives the main results of the various examples.

| | | According to | | According to |
|---|---|---|---|---|
| | Prior art | the invention | Prior art | the invention |
| | Water temperature | | | |
| | 126.5° C. | 126.5° C. | 65.7° C. | 65.7° C. |
| | Example 1 | Example 2 | Example 3 | Example 4 |
| Fluid | | Butane | | Propane |
| Power production | 5.2 | 5.75 | 4.45 | 4.54 |
| (MWe) | | | | |
| Required cooling | 5.5 | 4.9 | 5.3 | 5.2 |
| power (MWth) | | | | |

According to the invention, using an additional cooling cycle for the transfer fluid comprising hydrocarbons, whose nature is selected depending on the temperature of the water, allows the CAES method and system to produce more electricity and to expend less energy for cooling the recycled transfer liquid, water or oil for example. This gain is all the more significant since the final temperature of the transfer liquid is higher.

1. A compressed-air energy storage and production method comprising the following steps:
a) compression of the air by staged compressors (K-101, K-102, K-103, K-104), during which cooling of the air is performed after at least one compression stage through exchange with a heat transfer fluid (C-101, C-102, C-103, C-104),
b) storage of the compressed air and of the hot heat transfer fluid after exchange during compression,
c) staged expansions of the air by power generation turbines (EX-201, EX-202, EX-203, EX-204), during which heating of the air is performed after at least one expansion stage by the hot heat transfer fluid from the storage (C-101, C-102, C-103, C-104),
characterized in that, after heating the expanded air and prior to being recycled to the compression step, the transfer fluid is cooled by an additional energy recovery loop comprising a pump (P-501), an exchanger (E-501) and a turbine (EX-501), as well as an additional heat transfer fluid.

2. A method as claimed in claim 1, wherein the fluid used for heat transfer with the air is selected from among water, mineral oils, ammonia solutions.

3. A method as claimed in claim 1, wherein the additional transfer fluid is selected from among hydrocarbons, such as butane and propane, and ammonia solutions.

4. A method as claimed in claim 1, wherein heat exchange equipments (C-101, C-102, C-103, C-104) are common to the compression and compressed air expansion steps.

5. A method as claimed in claim 1, wherein at least one heat exchange equipment (C-101, C-102, C-103, C-104) uses the technology of heat exchange without direct contact between the fluids.

6. A method as claimed in claim 1, wherein at least one heat exchange equipment (C-101, C-102, C-103, C-104) uses the technology of heat exchange with direct contact between the fluids.

7. A method as claimed in claim 6, wherein at least one separator (V-101, V-102, V-103, V-104) is arranged on the compressed or expanded air line, so as to control a mass transfer between the heat transfer fluid and the air.

8. A method as claimed in claim 6, wherein the direct-contact heat exchange equipments comprise packed columns or plate columns.

9. A method as claimed in claim 1, wherein the heat transfer fluid is stored in an intermediate storage means (T-406) prior to exchanging heat with the additional transfer fluid.

10. A compressed-air energy storage and production system comprising:
a) staged compressors (K-101, K-102, K-103, K-104), and at least one heat exchanger (C-101, C-102, C-103, C-104) with a heat transfer fluid is arranged between a compression stage,
b) a compressed air storage means (T-201) and a means (T-402, T-403, T-404, T-405) of storing the hot heat transfer fluid after exchange during compression,
c) power generation turbines (EX-201, EX-202, EX-203, EX-204), and at least one heat exchanger (C-101, C-102, C-103, C-104) with the heat transfer fluid is arranged between an expansion stage,
wherein the system comprises an additional energy recovery loop including a pump (P-501), an exchanger (E-501), a turbine (EX-501) and an additional transfer fluid, the additional recovery loop being positioned after heating of the expanded air and prior to being recycled to the compression step.

11. A system as claimed in claim 10, wherein the fluid used for heat transfer with the air is selected from among water, mineral oils, ammonia solutions.

12. A system as claimed in claim 10, wherein the additional transfer fluid is selected from among hydrocarbons, such as butane and propane, and ammonia solutions.

13. A system as claimed in claim 10, wherein heat exchangers (C-101, C-102, C-103, C-104) are common to the compression and compressed air expansion steps.

14. A system as claimed in claim 10, wherein at least one heat exchanger (C-101, C-102, C-103, C-104) uses the technology of heat exchange without direct contact between the fluids.

15. A system as claimed in claim 10, wherein at least one heat exchanger (C-101, C-102, C-103, C-104) uses the technology of heat exchange with direct contact between the fluids.

16. A system as claimed in claim 15, wherein at least one separator (V-101, V-102, V-103, V-104) is arranged on the compressed or expanded air line, so as to control a mass transfer between the heat transfer fluid and the air.

17. A system as claimed in claim 15, wherein the direct-contact heat exchange equipments comprise packed columns or plate columns.

18. A system as claimed in claim 10, wherein the system comprises a means (T-406) for intermediate storage of the heat transfer fluid positioned before the additional recovery loop.
